(19) United States
(12) Patent Application Publication
(10) Pub. No.: US 2010/0038494 A1
(43) Pub. Date: Feb. 18, 2010

(54) LOOP HANGER WITH INTEGRAL WASHER

(76) Inventors: Eric C. Osborn, Medina, OH (US); Raymond M. Olle, Broadview Heights, OH (US)

Correspondence Address: Jonathan A. Platt;Renner, Otto, Boisselle & Sklar, LLP, 1621 Euclid Ave. - 19th Floor, Cleveland, OH, 44115, US

(21) Appl. No.: 12/512,069

(22) Filed: Jul. 30, 2009

Related U.S. Application Data
(60) Provisional application No. 61/088,370, filed on Aug. 13, 2008.

(51) Int. Cl. F16L 3/08

(52) U.S. Cl. 248/58

(57) ABSTRACT

A loop hanger, such as for supporting fire sprinkler pipe, contains an integral fold-over washer with an annular stiffening rib, the benefits of which are to minimize deflection of the horizontal ears of the hanger under an applied load and offer simplified installation by eliminating the need for additional flat washers.

This application claims priority under 35 USC 119 to U.S. Provisional Patent Application No. 61/088,370, filed Aug. 13, 2008, which is incorporated herein in its entirety.

### BACKGROUND OF THE INVENTION

1. Technical Field of the Invention

The invention relates in general to loop hangers.

2. Description of the Related Art

In its simplest form, a loop hanger consists of a strip of stamped steel formed with a loop such that the hanger profile resembles the shape of a pear (hence the alternative name of “pear hanger” for this style of hanger). The loop is sized to closely fit the outside diameter of the pipe being supported. Legs extend up and in on either side of the pipe. At the top of each leg are formed horizontal tabs (or ears) with punched holes sized to accept a threaded rod. The hanger is placed around the pipe and the ears are pushed together, one on top of the other, so that the punched holes are aligned. A threaded rod is inserted through the now concentric holes and secured to the loop hanger using hex nuts and flat washers on top and bottom of the overlapping ears. Prior loop hangers used to support fire sprinkler piping often require the installation of flat washers between the hex nuts to provide support for the horizontal tabs and minimize deflection during application of load. The end result is a somewhat rigid composite structure relatively resistant to bending moments.

Hangers used to support sprinkler piping in the United States must meet the technical requirements of NFPA13, “Installation of Sprinkler Systems”, and be “listed” by a third party agency such as Underwriters Laboratories (UL). UL tests candidate hangers to the requirements of the internal test standard, “UL203 Pipe Hanger Equipment for Fire Protection Service.” Similar standards and approval agencies exist in other regions of the world (e.g., VdS, LPCB). In addition to the UL requirements, other approval agencies such as Factory Mutual Research Corporation (FMRC) may list additional performance requirements, such as a deflection requirement. Deflection is effectively the amount the loop hanger “stretches” when the test load is applied. There are a number of methods employed by manufacturers for strengthening a loop hanger to meet the deflection requirements—the simplest involves making the hanger out of a thicker or stronger strap; a second involves adding the aforementioned flat washers above and below the two hex nuts; and a third involves shortening the horizontal tabs to reduce the amount unsupported length on the overlapping tabs. Each solution presents additional issues such as increased cost or increased difficulty during installation.

Among the myriad of issues with using traditional loop hangers:
Loop hangers are generally considered a commodity product purchased based on price and availability (since all hangers used for fire protection must be listed/approved all manufacturers are considered on even footing from the application standpoint). This said, adding thicker, wider or stronger material to stiffen the loop is not desirable due to the extra material cost involved.
Installers need clearance at the top of the loop for fingers and wrenches so they can install and tighten the lower nut. Shortening the horizontal tabs to reduce deflection decreases the amount of space an installer has when tightening the washer and nut.
The clearance mentioned above leads to unsupported portions on the loop hanger that deflect under load (because the hex nuts do not extend out to the legs of the loop hanger), leading to the need to add flat washers that provide additional support to the horizontal tabs. The washers improve the deflection performance because they extend out farther than the nuts, and when compressed between the nuts the washers form a composite surface with the horizontal tabs on the loop hanger.
A manufacturer not desiring to add material or shorten the horizontal tabs will require flat washers be installed under the top and bottom nuts so the deflection requirement can be met.
Most manufacturers will not supply the flat washers or hex nuts, as there is a packaging issue, since the hardware is usually supplied in bags of 50 or 100 pieces, but the hangers themselves are sold by the piece.
The washers also create another issue—dealing with more loose parts during the installation (more loose parts means higher probability of dropping parts during the install).

Even though the washers must be installed to comply with a particular agency approval, many installers will not go through the trouble of finding or using the washers. The result is that loop hangers are installed that are in non-compliance with the specific agency listing/approval.

### SUMMARY OF THE INVENTION

A loop-style (hereafter referred to as “loop”) hanger, such as for supporting fire sprinkler pipe, contains an integral fold-over washer with an annular stiffening rib, the benefits of which are to minimize deflection of the horizontal ears of the hanger under an applied load and offer simplified installation by eliminating the need for additional flat washers.

According to an aspect of the invention, a loop hanger has an integral fold-over washer that functions as a strengthening element.

According to another aspect of the invention, a loop hanger has an integral fold-over washer constructed from the base material of the hanger, and attached via a carry tab to the parent product.

According to yet another aspect of the invention, a loop hanger has an integral fold-over washer with a tail that extends past the horizontal portion of the washer. The tail may proceeds downward at an angle that matches that of an opposing leg. The tail serves to provide additional support during deflection.

According to still another aspect of the invention, a loop hanger has a stiffening rib that consists of a raised annular surface within a fold-over washer that enhances its structural stiffness.

According to another aspect of the invention, an integral washer of a loop hanger has one or more ribs that provide added stiffness.

According to a further aspect of the invention, a loop hanger includes a metal strip that in turn includes: a rounded pipe-receiving bottom portion; first and second legs rising from opposite respective ends of the rounded pipe-receiving portion; and first and second tabs at ends of the first and second legs, respectively, wherein the tabs overlap at a top of the hanger, wherein the tabs have respective holes that are aligned for receiving a rod therethrough; wherein the first tab has a washer of the loop hanger attached thereto.

According to a still further aspect of the invention, a method of securing a pipe includes the steps of: placing the pipe in a rounded bottom portion of a loop hanger; and securing the loop hanger to a rod, wherein the rod passes through a pair of tabs of the loop hanger, and through a folded-over washer of the loop that is integrally formed with at least one of the tabs as part of a continuous monolithic metal strip.

According to another aspect of the invention, a loop hanger includes:a rounded pipe-receiving bottom portion; a pair of legs rising from opposite respective ends of the rounded pipe-receiving portion; and at least three layers of material overlapping at a top of the hanger, and having respective holes that are aligned for receiving a rod therethrough; wherein the bottom portion, the legs, and the at least three layers of material are all parts of a continuous monolithic metal strip.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

The annexed drawings, which are not necessarily according to scale, show various aspects of the invention.

FIG. 1 is a side view of a loop hanger in accordance with an embodiment of the present invention.

FIG. 2 is a detail view of a part of the loop hanger of FIG. 1, showing stiffening elements in a bend of the hanger.

FIG. 3 is a detail view of another part of the loop hanger of FIG. 1, showing stiffening elements and an annular stiffener.

FIG. 4 is a cross-sectional view of the lower part of the loop hanger of FIG. 1.

FIG. 5 is an oblique view of an application assembly that includes the loop hanger of FIG. 1.

FIG. 6 is a side view of an alternate embodiment loop hanger in accordance with the invention.

FIG. 7 is a top view of a top part of the loop hanger of FIG. 6.

### DETAILED DESCRIPTION

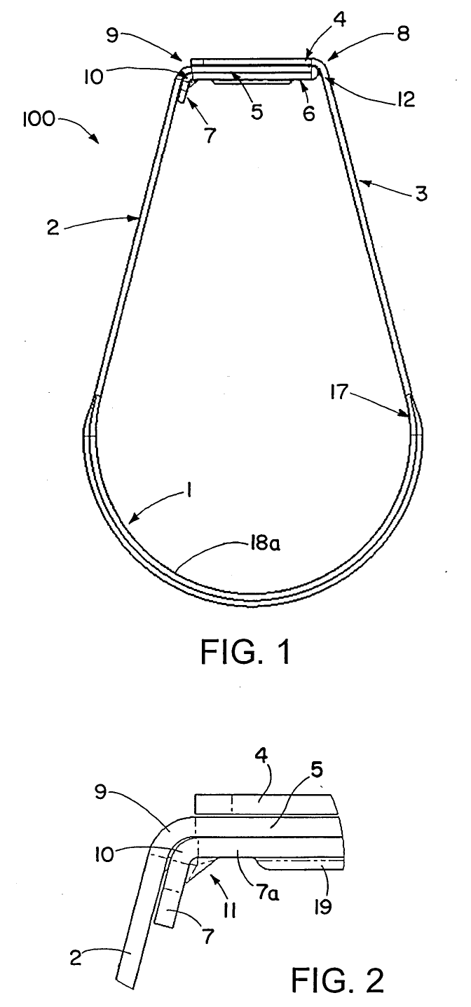

Referring to FIGS. 1-4, a loop hanger 100 is a formed steel strip, and is used to support steel or plastic piping. The loop hanger 100 consists primarily of a large rounded bottom portion or loop 1, a pair of angled upward-extending legs 2 and 3, top and bottom horizontal tabs 4 and 5, and an integral fold-over washer 6 with a tail 7. The rounded bottom portion 1, the legs 2 and 3, the tabs 4 and 5, and the washer 6 all may be integral parts of a single monolithic continuous metal strip, such as a strip of steel, for example stainless steel. The loop 1 contacts the pipe being supported, and may be sized to closely match the diameter of the pipe.

Bends 8 and 9 are used to form the top and bottom horizontal tabs 4 and 5, respectively. A bend 10 used to form the fold-over washer tail 7, bending the tail 7 downward from a horizontal portion 7a of the washer 6. The tail 7 may be bent at an angle corresponding to the slope of the leg 2. This allows an outside surface of the tail 7 to press against an inside surface of the leg 2, providing better structural stability for the loop hanger 100 when the hanger 100 is fully assembled and installed. The bends 8, 9, and 10 all have appropriate suitable radiuses, as dictated by good metal forming practice. A 180-degree hem bend 12 is utilized at the interface between the bottom horizontal tab 5 and the fold-over washer 6.

Stiffening elements (gussets) 11 are centered on inside surfaces of the bends 8 and 10, to increase stiffness and reduce deflection of the top and bottom horizontal tabs. One pair of the stiffening elements or gussets 11 is located at the inside of the bend 8, coupled to both the leg 3 and the tab 4. Another pair of the stiffening elements or gussets 11 is located at the bend 10, coupled to both parts of the washer 6, the tail 7 and the horizontal portion 7a. The stiffening elements or gussets 11 may be stamped indentations, deformations of the material of the metal strip located at the bends 8 and 10. Alternatively the gussets (stiffening elements) 11 may be separate triangular pieces of material, with flat edges against each of the two parts linked by any particular of the gussets 11. Such separate-piece gussets 11 may be welded or otherwise suitably attached to the parts that they link together.

The fold-over washer 6 and fold-over washer tail 7 nest inside the bottom horizontal tab 5 with minimal gap. Small clearance holes (cutouts) 13 are located on the 180-degree hem bend 12 to prevent interference with the stiffening elements or gussets 11 located on the top horizontal tab bend 8 and ensure proper nesting of the top and bottom horizontal tabs 4 and 5. The top and bottom horizontal tabs 4 and 5, and the integral fold-over washer 6, have respective closed round holes 14,15, and 16, to allow an appropriate sized threaded rod to pass through. Nuts are used above the top horizontal tab 4 and below the integral fold-over washer 6 to secure the loop hanger 100 to a threaded rod, which may be secured to building structure, such as a ceiling or fixture.

The tabs 4 and 5, and the washer 6, constitute three layers of material overlapping and in contact with one another, providing stiffness at the top of the hanger 100, around the rod-receiving holes 14-16 in the material layers. It will appreciated that alternatively additional layers of material may be folded over and stacked onto the tabs 4 and 5, and the washer 6. Such optional additional layers may be folded over from the tab 4 or the washer 6, for example.

The loop 1 has noticeably flared edges 17a and 17b covering more than the bottom 180 degrees of the loop 1. A substantial radius 18 is provided between a substantially flat central portion 18a of the loop 1, and each of the edges 17a and 17b that slope away from it. The flared edges 17a and 17b extend outward and down, such as at an approximately 45 degree angle, from the central portion. The flared edges 17a and 17b prevent the supported pipe from contacting sharp edges that would otherwise be present in the formed loop 1. This is advantageous, particularly for applications involving plastic pipe, in which the presentation of sharp edges can result in damage to the pipe.

An annular rib 19 is formed in the fold-over washer 6 concentric to the closed round hole 16. The rib 19 extends in a downward direction toward the supported pipe (toward the loop hanger bottom 1). The diameter of the rib 19 is sized to provide bearing area for the bottom hex nut used to secure the threaded rod to the loop hanger. Under load the horizontal tabs 4 and 5 will attempt to bend at the edge of the bottom hex nut. The annular rib 19 increases stiffness in this area and hence reduces deflection. The rib 19 may be a stamped feature, with the stamping used to deform some of the material around the hole 16 to produce the annular rib 19.

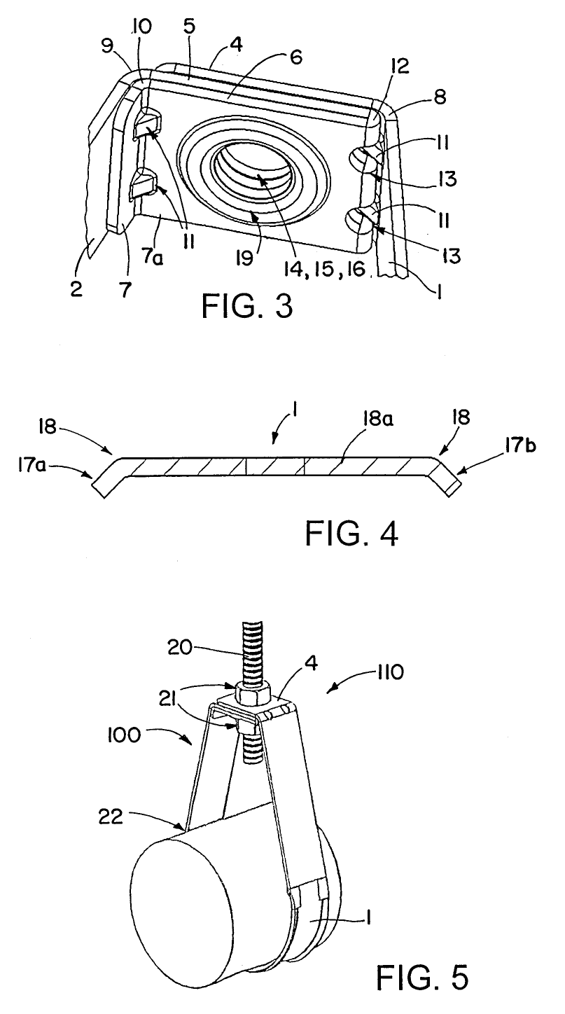

FIG. 5 shows the loop hanger 100 as part of an installation 110 for supporting a pipe 22. The loop hanger 100 is supported on a threaded rod 20, with the threaded rods 20 passing through the holes 14-16 (FIG. 3) in the tabs 4 and 5 (FIG. 1), and the washer 6 (FIG. 1). The threaded rod 20 may be connected to a ceiling, fixture, or other building structure (not shown). Hex jam nuts 21 are threaded onto the threaded rod 20 above and below the washer 6 and the tabs 4 and 5. The nuts 21 are tightened against the upper tab 4 and the washer 6 to secure the hanger 100 in place on the threaded rod 20. The pipe 22 is surrounded by the loop hanger 100, with the pipe 22 resting in the rounded bottom portion loop 1, against the inside surface of the flat central portion 18a (FIG. 4) of the loop 1.

The combined effect of the integral fold-over washer 6, annular rib 19, and gussets (stiffening elements) 11 allow the loop hanger 100 to achieve high performance with less material content, specifically in regard to the ability to resist deflection. Furthermore, this performance can be achieved without the use of additional flat washers, as are commonly required in the industry. It will be appreciated that a loop hanger need not necessarily utilize both features (integral fold-over washer 6 and annular stiffening rib 19) to enjoy improved performance. It has been found that the more important feature in terms of stiffening is the integral fold-over washer 6, although both features are separately advantageous, as well as being advantageous in combination. The addition of the annular stiffening rib enhances the performance even further, but by itself may not allow the hanger to meet the deflection requirements with a minimum material condition. It will be appreciated that the integrated fold-over washer 6 does not necessarily have to extend across the full length of the bottom tab 5 and proceed down the opposite leg 2. Alternatively, a shorter fold-over washer may deliver the desired support without the extra length.

The addition of the integrated fold-over washer 6 and/or the annular rib 19 eliminates the need to add flat washers to a loop hanger installation for additional support. This reduces the number of parts and installation time. This solution also allows a loop hanger to meet agency deflection requirements with less material (thinner, narrower, lower strength).

An alternative configuration would be to provide a series of longitudinal ribs on both the fold-over washer 6 and the lower horizontal tab 5, such as horizontal ribs, very similar in form to corrugations found in cardboard. However it was found that the annular rib 19 performed better than the horizontal ribs.

The shape of the annular rib 19 could be modified to deliver similar stiffness without the circular (annular) shape. For example, a series of corrugations, similar to those found in corrugated cardboard, could deliver comparable stiffness to the annular rib 19. Further, if the bottom tab 5 also possessed corrugations such that the bottom tab 5 and the corrugated fold-over washer 6 nested within each other, they would create a very strong composite structure.

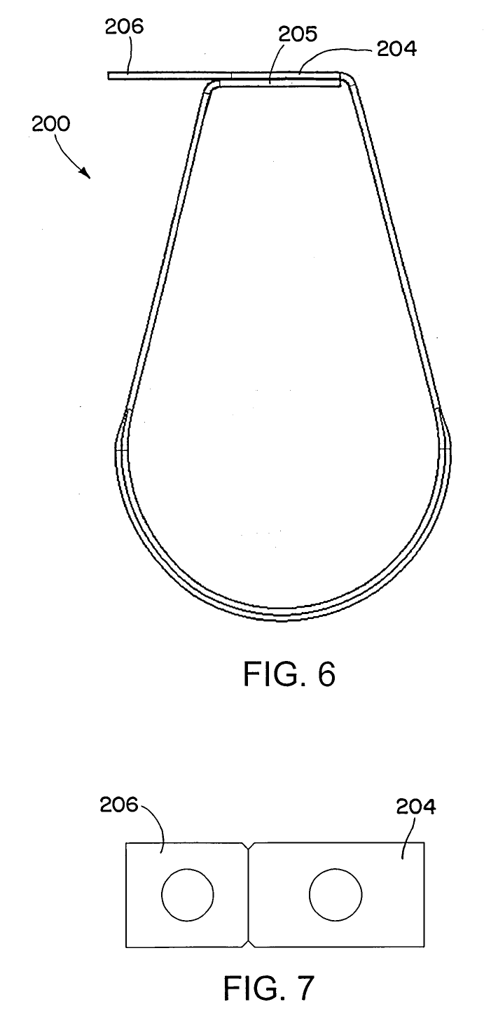

FIGS. 6 and 7 illustrate an alternate embodiment loop hanger 200, in which a washer 206 attached to the end of the top horizontal tab 204 via a carry tab (usable to carry the hanger 200 prior to separation of the washer 206). At the time of installation, an installer would simply break off the washer 206 and install it on the bottom side of the lower horizontal tab 205. There may be score lines or other weakening of material to allow separation of the washer 206 from the tab 205. The break-off washer 206 would function the same as a typical round washer, but an advantage is that an installer would not have to go out and find the washer, but instead would use the attached washer 206. Other features of the loop hanger 200 may be similar to corresponding features of the loop hanger 100 (FIG. 1). The configuration of the loop hanger 200 does have the advantage of providing the entire loop hanger as a single piece, solving the issue of finding the washer at the time of installation. However, after the washer 206 is detached it is still loose, meaning that it could be dropped. The loop hanger 100 has the advantage of having its washer 6 attached to the end of the lower horizontal tab 5, and folded under so the installer does not have to go through any additional steps during the installation.

The integral fold-over washer could be employed as a stiffening member for other hangers, such as loop hangers that utilize swaging to draw out the material to a width larger than the base width such that a threaded rod can be inserted into a hole in the center of the swaged portion. Adding the integral fold-over washer with a swaged section would provide the dual benefit of stiffening the tabs and improving the tear-out performance of the loop hanger. In addition, even a clevis style hanger would benefit from the fold-over washer, as it would provide additional stiffness to the top half of the clevis hanger, which is the weakest (and therefore least robust) portion of a clevis hanger.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A loop hanger comprising:
a metal strip that includes:
a rounded pipe-receiving bottom portion;
first and second legs rising from opposite respective ends of the rounded pipe-receiving portion; and
first and second tabs at ends of the first and second legs, respectively, wherein the tabs overlap at a top of the hanger, wherein the tabs have respective holes that are aligned for receiving a rod therethrough;
wherein the first tab has a washer of the loop hanger attached thereto.

2. The loop hanger of claim 1, wherein the washer is folded over from the first tab.

3. The loop hanger of claim 1, wherein the first tab has a tail, a downward-bent portion at an end of the first tab, that presses against an inside surface of the second leg.

4. The loop hanger of claim 1, wherein the washer has an annular rib around its hole, whereby the annular rib strengthens the one of the tabs.

5. The loop hanger of claim 1, wherein the washer and the first tab are below the second tab, closer to than the second tab to the bottom portion.

6. The loop hanger of claim 1, wherein the rounded bottom portion has side flanges angled away from a central pipe-receiving surface, thereby providing separation between edges of the bottom portion and an object resting against the central pipe-receiving surface.

7. The loop hanger of claim 1, further comprising one or more stiffening elements at a bend between the second leg and the second tab, thereby providing additional stiffness.

8. The loop hanger of claim 7,
wherein the washer is folded over from the first tab;
wherein the first tab has a tail, a downward-bent portion at an end of a horizontal portion of the first tab, that presses against an inside surface of the second leg; and
further comprising one or more additional stiffening elements at a bend between the horizontal portion and the tail.

9. The loop hanger of claim 8, wherein the one or more stiffening elements at the bend between the second leg and the second tab are located in cutouts in the first tab and the washer.

10. The loop hanger of claim 8, wherein the washer has an annular rib around its hole, whereby the annular rib strengthens the one of the tabs.

11. The loop hanger of claim 10, wherein the washer and the first tab are below the second tab, closer to than the second tab to the bottom portion.

12. The loop hanger of claim 10, wherein the rounded bottom portion has side flanges angled away from a central pipe-receiving surface, thereby providing separation between edges of the bottom portion an object resting against the central pipe-receiving surface.

13. The loop hanger of claim 1, wherein the washer is a break off washer that is separated from the strip by an end user prior to installation.

14. The loop hanger of claim 1, wherein the metal strip is a stainless steel strip.

15. A method of securing a pipe, the method comprising:
placing the pipe in a rounded bottom portion of a loop hanger; and
securing the loop hanger to a rod, wherein the rod passes through a pair of tabs of the loop hanger, and through a folded-over washer of the loop that is integrally formed with at least one of the tabs as part of a continuous monolithic metal strip.

16. A loop hanger comprising:
a rounded pipe-receiving bottom portion;
a pair of legs rising from opposite respective ends of the rounded pipe-receiving portion; and
at least three layers of material overlapping at a top of the hanger, and having respective holes that are aligned for receiving a rod therethrough;
wherein the bottom portion, the legs, and the at least three layers of material are all parts of a continuous monolithic metal strip.

17. The loop hanger of claim 16, wherein one of the layers of material has a raised annular rib around the hole of the one of the layers.

18. The loop hanger of claim 16, wherein one of the layers of material is a washer that is folded over onto another of the layers of material.

19. The loop hanger of claim 18, wherein the washer has a tail at a free end that is folded down at substantially the same angle as one of the legs, and is in contact with the one of the legs.

20. The loop hanger of claim 16, wherein the metal strip is a steel strip.
